(19) United States
(12) Patent Application Publication
(10) Pub. No.: US 2019/0272334 A1
(43) Pub. Date: Sep. 5, 2019

(54) INFORMATION PROCESSING DEVICE, INFORMATION PROCESSING METHOD, AND NON-TRANSITORY COMPUTER READABLE MEDIUM STORING INFORMATION PROCESSING PROGRAM

(71) Applicant: FUJI XEROX CO., LTD., Tokyo (JP)

(72) Inventors: Daisuke YASUOKA, Kanagawa (JP); Kiichiro ARIKAWA, Kanagawa (JP)

(73) Assignee: FUJI XEROX CO., LTD., Tokyo (JP)

(21) Appl. No.: 16/110,487

(22) Filed: Aug. 23, 2018

(30) Foreign Application Priority Data
Mar. 5, 2018 (JP) 2018-038823

(51) Int. Cl. G06F 17/30

(52) U.S. Cl. CPC G06F 17/30029

(57) ABSTRACT

An information processing device includes a providing unit that identifies information desired by a user from answers to questions, and when relevant information related to the identified desired information is acquired, provides the relevant information to the user.

### CROSS-REFERENCE TO RELATED APPLICATIONS

This application is based on and claims priority under 35 USC 119 from Japanese Patent Application No. 2018-038823 filed on Mar. 5, 2018.

### BACKGROUND

### Technical Field

The present invention relates to an information processing device, an information processing method, and a non-transitory computer readable medium storing an information processing program.

### SUMMARY

According to an aspect of the invention, there is provided an information processing device including a providing unit that identifies information desired by a user from answers to questions, and when relevant information related to the identified desired information is acquired, provides the relevant information to the user.

### BRIEF DESCRIPTION OF THE DRAWINGS

Exemplary embodiment of the present invention will be described in detail based on the following figures, wherein:

FIG. 1 is a diagram illustrating a schematic configuration of an information processing system according to an exemplary embodiment of the invention;

FIG. 2 is a block diagram illustrating a hardware configuration of the information processing device;

FIG. 3 is a block diagram illustrating an example of a functional configuration of the information processing device;

FIG. 4 is a view illustrating an example of an image of an answer sheet;

FIG. 5 is a view illustrating an example of information registered in a user information registry unit;

FIG. 6 is a view illustrating an example of a screen displayed by the information processing device;

FIG. 7 is a flowchart illustrating a flow of information processing performed by the information processing device; and

FIG. 8 is a flowchart illustrating a flow of search processing.

### DETAILED DESCRIPTION

Hereinafter, an exemplary embodiment of the present invention will be described with reference to the drawings. It is to be noted that the same or equivalent components and parts in the drawings are labeled with the same reference symbol. Also, the dimension ratio in the drawings is significantly changed for the sake of convenience of description, and may be different from the actual ratio.

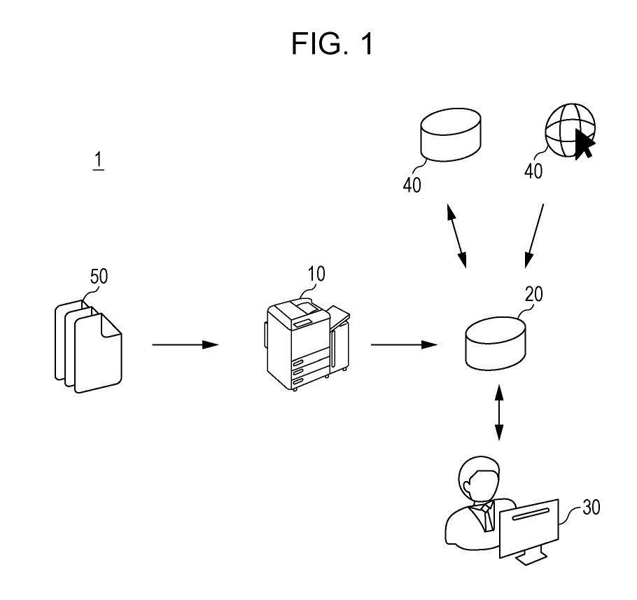

FIG. 1 is a diagram illustrating the schematic configuration of an information processing system according to an exemplary embodiment of the invention.

As illustrated in FIG. 1, the information processing system has an answer acquisition device 10, an information processing device 20, a user terminal 30, and databases 40.

The answer acquisition device 10 is a device that acquires answers to questions. The answers to questions may be acquired as any type of data, such as image data, character data, voice data, or video data. When an answer is acquired as image data, the answer acquisition device 10 is an imaging device such as a multifunctional device capable of performing functions such scanning, printing, and copying, a scanner having a scan function, or a camera or a smart glass including an imaging device. The answer acquisition device 10 reads an image of a sheet, such as an answer sheet 50, on which an answer (solution) is written, and acquires image data. The answer acquisition device 10 may include an optical character recognition reader that extracts characters from read image data and recognizes the characters. When an answer is acquired as character data, the answer acquisition device 10 may be any device including a communication interface for receiving character data. When voice data is acquired, the answer acquisition device 10 is a device that has a voice recognition function that converts voice data into character data. When video data is acquired, the answer acquisition device 10 is a device that converts the voice data included in a video to character data by a voice recognition function, and cuts out images from a video to retrieve character data. Like this, the answer acquisition device 10 can acquire an answer in various manners. In the exemplary embodiment below, the case where image data of the answer sheet 50 is acquired as an answer will be described.

The information processing device 20 identifies information desired by a user, in other words, information in which a user is interested from an answer acquired by the answer acquisition device 10, and acquires information related to information desired by a user from the database 40 and provides the information to a user. In the present description, information related to information desired by a user is called relevant information. The information desired by a user is, for instance, information on a word a user wants to know (check), and the relevant information is information that explains the meaning of the word a user wants to know. A detailed description of the information processing device 20 will be given later.

The user terminal 30 can communicate with the information processing device 20, and allows a user to utilize relevant information acquired by the information processing device 20. The user terminal 30 includes an input device such as a mouse or a keyboard, and a display device such as a display. A user can utilize the functions of the information processing device 20 by inputting a user ID and a password to the information processing device 20 via the user terminal 30. In response to input of a user ID and a password, the information processing device 20 identifies the user who is utilizing the user terminal 30, and performs information processing by utilizing user information on the user.

The database 40 is a device that stores relevant information and can communicate with the information processing device 20. The database 40 may be a specific device, or many unspecified devices accessible via the Internet. In addition, as a specific device, the database 40 may store results of graded answers to the same or similar questions on exams conducted by other schools and other educational institutions.

Next, a hardware configuration of the information processing device 20 will be described.

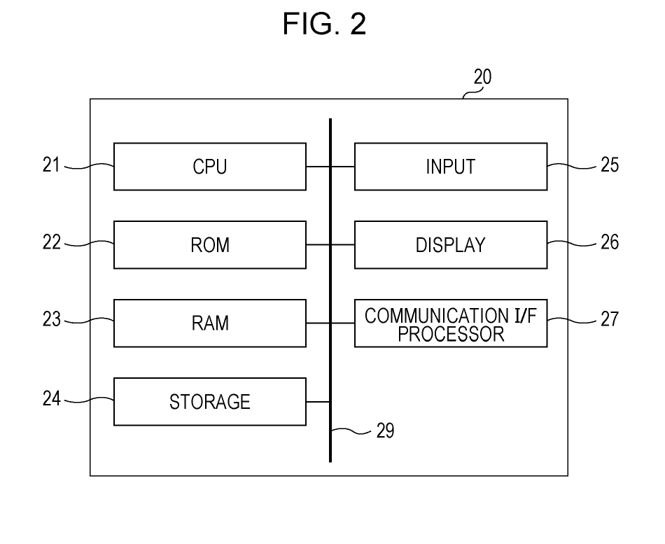

FIG. 2 is a block diagram illustrating the hardware configuration of the information processing device.

As illustrated in FIG. 2, the information processing device 20 includes the components: a central processing unit (CPU) 21, a read only memory (ROM) 22, a random access memory (RAM) 23, a storage 24, an input 25, a display 26, and a communication interface 27. The components are coupled to each other via a bus 29 to allow communication therebetween.

The CPU 21 is a central processing unit, and executes various programs and controls each component. Specifically, the CPU 21 reads a program from the ROM 22 or the storage 24, and executes the program using the RAM 23 as a workspace. The CPU 2 controls the components and performs various types of calculation processing in accordance with programs stored in the ROM 22 or the storage 24. In the exemplary embodiment, the ROM 22 or the storage 24 stores information processing programs.

The ROM 22 stores various programs and various types of data. The RAM 23 serves as a workspace to temporarily store programs or data. The storage 24 is configurated by a hard disk drive (HDD) or a solid state drive (SSD), and stores various programs including an operating system, and various types of data.

The input 25 includes a pointing device such as a mouse, and a keyboard, and is used to perform various inputs.

The display 26 is, for instance, a liquid crystal display, and displays various types of information. The display 26 adopts a touch-panel, and may function as the input 25.

The communication interface 27 is an interface for communicating with other devices such as the answer acquisition device 10, the user terminal 30, and the database 40, and for instance, standards such as Ethernet (registered trademark), FDDI, and Wi-Fi (registered trademark) are used.

Next, the functional configuration of the information processing device 20 will be described.

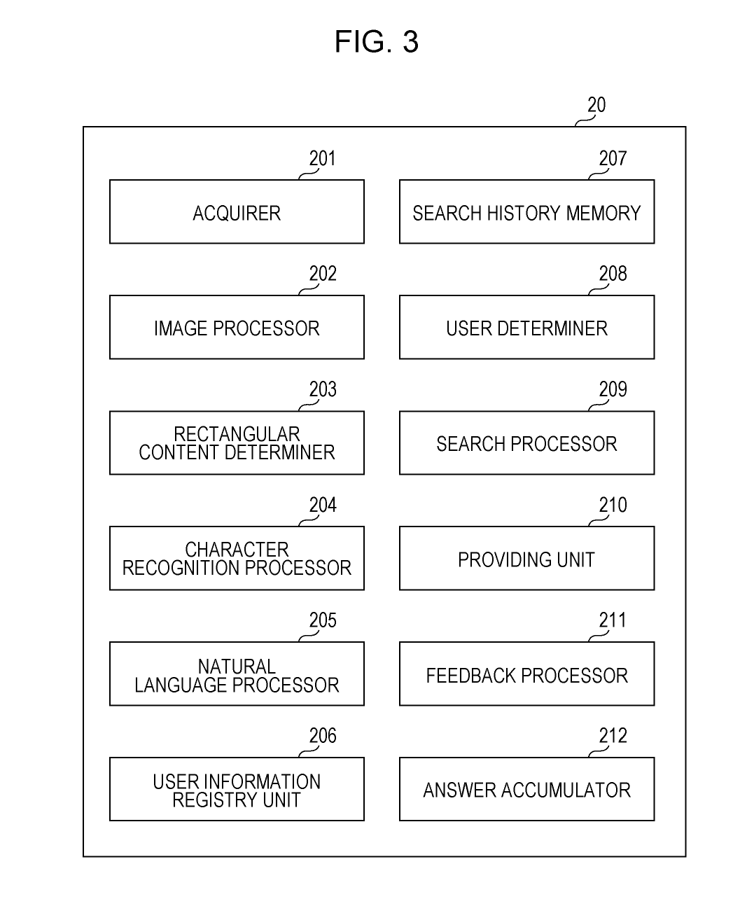

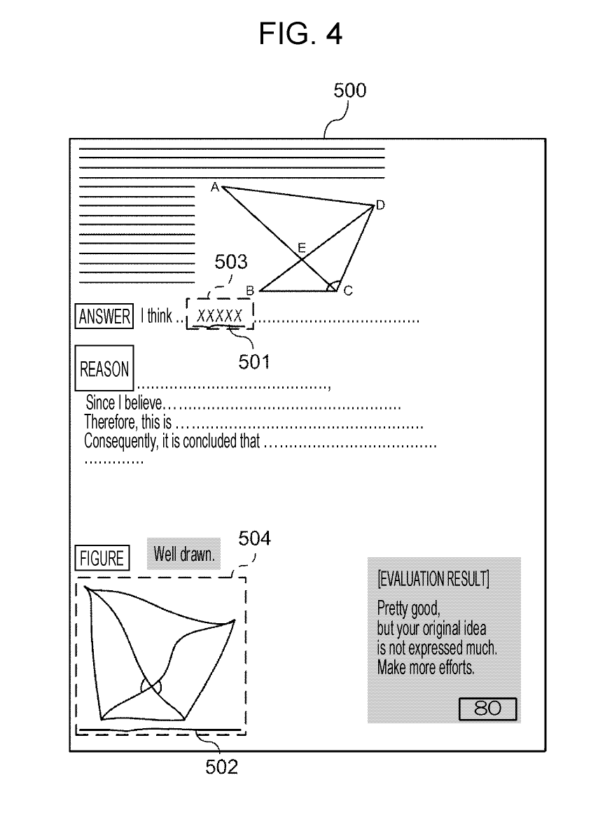

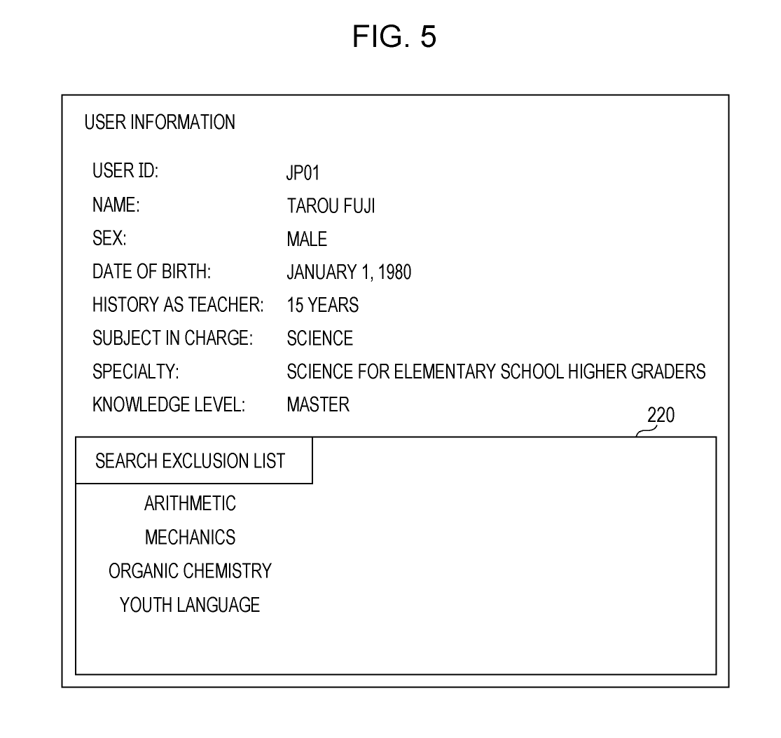

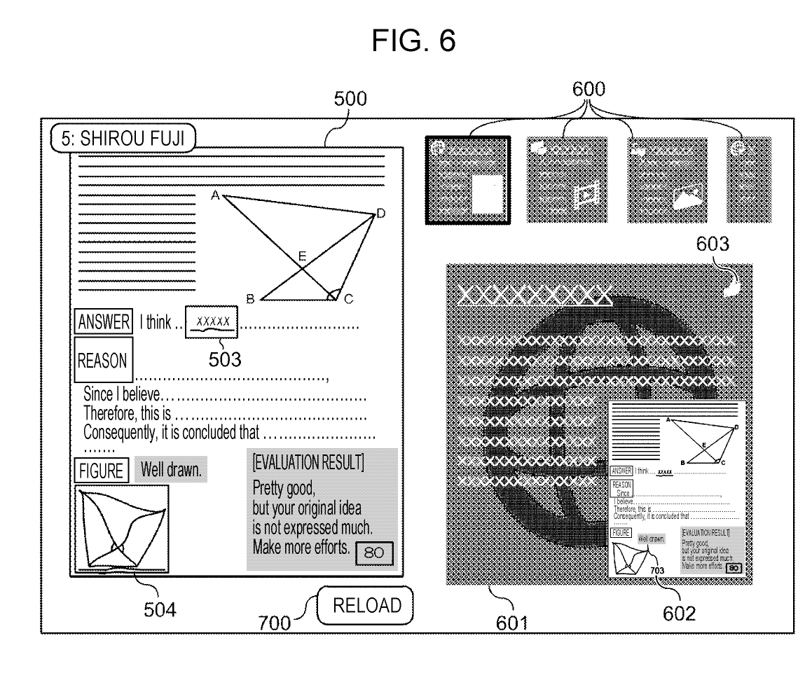

FIG. 3 is a block diagram illustrating an example of the functional configuration of the information processing device. FIG. 4 is a view illustrating an example of an image of an answer sheet. FIG. 5 is a view illustrating an example of information registered in a user information registry unit. FIG. 6 is a view illustrating an example of a screen displayed by the information processing device.

As illustrated in FIG. 3, the information processing device 20 includes an acquirer 201, an image processor 202, a rectangular content determiner 203, a character recognition processor 204, a natural language processor 205, a user information registry unit 206, a search history memory 207, a user determiner 208, a search processor 209, a feedback processor 211, and an answer accumulator 212 as the functional configuration. The functional configuration is implemented by the CPU 21 that reads the information processing program stored in the ROM 22 or the storage 24, and loads and executes the information processing program in the RAM 23.

The acquirer 201 acquires the image data of the answer sheet 50 as information (hereinafter referred to as answer information) on an answer for a question. When a character written on the answer sheet 50 is recognized, the acquirer 201 also acquires character data together. The image data of the answer sheet 50 includes not only data indicating a character, but also data indicating a graphic or a photograph. It is to be noted that the information acquired as an answer for a question by the answer acquisition device 10 as described above is not limited to the image data of the answer sheet 50. The answer may be acquired as any data such as image data, character data, voice data, or video data. In the exemplary embodiment, a case is described in which the image data of the answer sheet 50 is acquired as the answer information.

The image processor 202 determines whether the image data acquired by the acquirer 201 includes designation information for designating information desired by a user. The designation information for designating desired information is, for instance, indicates an underline 501 and an underline 502 written in the answer in an image 500 of the answer sheet 50 as illustrated in FIG. 4. Without being limited to the underlines 501, 502, the designation information may be represented by any form as long as information in the answer sheet 50 desired by a user can be designated. For instance, the designation information may be a rectangle or a circle that surrounds a portion indicating desired information, or a marker overlapped with a portion indicating desired information.

When it is determined by the image processor 202 that designation information is included, the rectangular content determiner 203 sets the range of the desired information designated by the designation information, and determines the content in the range. For instance, the rectangular content determiner 203 detects upper line components of the range designated by the underlines 501, 502, identifies the group of the line components as a single character, and sets rectangular areas 503 and 504 indicated by a dotted line in FIG. 4 to the range including the desired information so that the identified character is surrounded. The rectangular content determiner 203 determines whether or not the content in the set range is a character image. The determination as to whether or not the content is a character image can be implemented, for instance, by image processing such as pattern matching or template matching. As in the example illustrated in FIG. 4, the rectangular content determiner 203 determines that the content in the area 503 is characters, and the content in the area 504 is not characters.

Based on the content determined to be characters by the rectangular content determiner 203, the character recognition processor 204 recognizes the characters by optical character recognition. On the other hand, when it is determined by the image processor 202 that designation information for designating desired information is not included (designation information such as the underline 501 is not written on the answer sheet 50), the character recognition processor 204 recognizes the characters in the entire range of the image of the answer sheet 50 by optical character recognition.

The natural language processor 205 recognizes meaningful characters and a character string, in short, a word, and further recognizes the structure of a sentence from the characters recognized by the character recognition processor 204. Since the technique of natural language processing is well-known, a description is omitted here.

The user information registry unit 206 registers user information regarding users. As illustrated in FIG. 5, the user information includes, for instance, user ID, name, sex, date of birth, and background of user. The background of user is a background regarding the knowledge and experience of users. The background of user includes, for instance, history as teacher or instructor, subject in charge, specialty, and knowledge level. The specialty includes, for instance, a course or a subject being learned by a user and a field in which a user excels, such as science, mathematics, mathematics III, and mechanics. The knowledge level includes, for instance, a level indicating a degree of speciality, such as a general level (high-school-educated level), a bachelor level, a master level, and a doctor level.

Also, the user information registry unit 206 includes a search exclusion list 220. The search exclusion list 220 is a list that indicates the keywords to be excluded as a search target when search is performed by the search processor 209. A keyword is added to or deleted from the keywords indicated by the search exclusion list 220 based on the search history stored in the later-described search history storage 207 and results of feedback made by the feedback processor 211.

The search history storage 207 stores a search history indicating the usage history of desired information retrieved by the search processor 209. As search histories, the search history storage 207 stores desired information which has been searched by the search processor 209 and utilized by users, and desired information which has been searched by the search processor 209 but not utilized by users. The desired information not utilized by users is determined to be information not desired by users, and may be added to the search exclusion list of FIG. 5.

Based on the user information registered in the user information registry unit 206, the user determiner 208 identifies the characters and character string desired by a user as the desired information from the characters and character strings included in answers obtained by the natural language processing unit 205. In addition, when relevant information related to the identified desired information is searched for, and multiple pieces of relevant information are found, the user determiner 208 determines the order of priority in presenting multiple pieces of search results to a user based on the user information and the search history.

The search processor 209 acquires a result of searching the database 40 as the relevant information using desired information as search information. As described above, the desired information is characters, a character string, or a graphic included in the area 503 set by the rectangular content determiner 203, in other words, characters, a character string, or a graphic designated via designation information by a user. Also, the desired information is the characters or character string identified by the user determiner 208 from the characters and character strings included in answers.

The search processor 209 further associates the acquired relevant information with the word identified as the desired information. The association is implemented as so-called link in which when a word, which is desired information included in an answer, is clicked (selected), relevant information related to the desired information is presented.

The providing unit 210 provides relevant information retrieved by the search processor 209 to a user. The providing unit 210 provides relevant information to a user, for instance, on the screen as illustrated in FIG. 6. On the screen illustrated in FIG. 6, the image 500 of the answer sheet 50 is displayed on the left side of the screen, and relevant information is displayed on the right side of the screen. For instance, on the image of the answer sheet 50, when the word identified as the desired information in the area 503 is clicked, relevant information is displayed on the right side. As described above, the relevant information is obtained as a result of searching the database, thus multiple pieces of relevant information may be obtained for one piece of desired information. On the upper part on the right side of the screen of FIG. 6, the beginning parts or the outlines of multiple pieces of desired information related to clicked desired information are displayed as thumbnails 600. Here, when one thumbnail 600 is clicked, the details are largely displayed as a detail 601 on the lower part on the right side of the screen. When an attached file 602 is provided, the attached file 602 may be displayed. The relevant information is not limited to many unspecified pieces of information available via the Internet, and may be information on the images of answers to the same or similar questions on exams in other schools. In this case, the search processor 209 has access to the database 40 of other schools, and acquires the images of answers. Similar questions may have relevant information and hints related to the information desired by users.

The feedback processor 211 receives feedback from a user about the relevant information retrieved by the search processor 209. For instance, on the screen illustrated in FIG. 6, when a user views relevant information and is pleased with the relevant information, the feedback processor 211 allows a user to select a specific icon 603 and receives feedback from the user. In addition to the icon 603 to be selected when a user is pleased with the relevant information, another icon 603 may be provided, which is to be selected when a user is not pleased with the relevant information. Feedback obtained by the feedback processor 211 is reflected in the search history of the search history storage 207. Even relevant information related to the same desired information, format, expression, and layout for explaining the desired information vary with website. An icon 603 indicating the preference of a user is selected, thereby accumulating information on website suiting the preference of the user and website not suiting the preference of the user in the search history. The user determiner 208 can determine the order of priority (order of arrangement) in presenting the search results obtained by the search processor 209 based on the accumulation of information on the preference of the user. Related information with a higher order of priority is displayed on the left side closer to the image of the answer sheet 50, for instance, in the arrangement of the thumbnails 600 of the upper part on the right side of the screen of FIG. 6. When the word in the area 503 is clicked, the content of the relevant information with the highest order of priority may be displayed as the detail 601.

The answer accumulator 212 accumulates the image 500 of the answer sheet 50 in association with each word identified as the information desired by the user in the answer sheet 50, and the retrieved relevant information.

Next, the function of the information processing device 20 will be described.

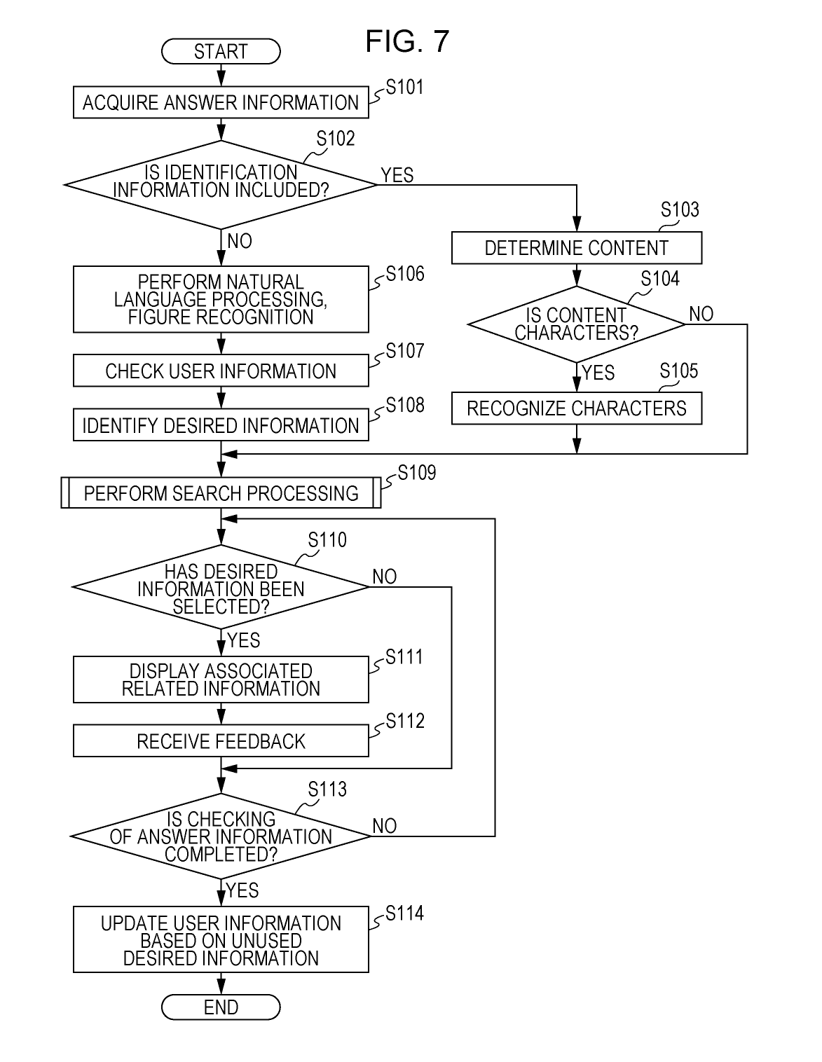

FIG. 7 is a flowchart illustrating the flow of information processing performed by the information processing device. Information processing is performed by the CPU 21 that reads the information processing program stored in the ROM 22 or the storage 24, and loads and executes the information processing program in the RAM 23.

The CPU 21 acquires answer information to questions as the acquirer 201 (step S101). In the exemplary embodiment, image data of answer sheets is acquired as the answer information.

As the image processor 202, the CPU 21 checks to see whether or not the answer information includes designation information that serves as an index of desired information (step S102). When designation information is included (YES in step S102), as the rectangular content determiner 203, the CPU 21 sets a rectangular range as the range of the desired information indicated by the designation information (step S103).

The CPU 21 determines whether or not the content of the desired information determined in step S103 is characters (step S104). When the content of the desired information is not characters (NO in step S104), in other words, the desired information is a graphic or a photograph, the CPU 21 causes the flow to proceed to the processing in step S109. When the desired information is characters (YES in step S104), the CPU 21 recognizes the characters as the character recognition processor 204 (step S105).

Returning to the description of step S102, when designation information is not included in the answer information (NO in step S102), the CPU 21 recognizes characters from the answer information, further recognizes words as the natural language processor 205, and also recognizes graphics other than characters if presented (step S106).

As the user determiner 208, the CPU 21 checks user information registered in the user information registry unit 206 (step S107), and identifies the desired information from the words and graphics recognized in step S106, based on the user information (step S108). Specifically, the desired information is identified in the following manner. The CPU 21 estimates information known to (learned by) a user from the user information illustrated in FIG. 5. For instance, when the subject in charge is science, the CPU 21 estimates that general words used in science are information known to the user. The words and graphics (symbols) used in the subject in charge are obtained as the words and graphics described in the curriculum guidelines of Ministry of Education, for instance. Similarly, for the knowledge level, the CPU 21 estimates that words pre-defined according to the knowledge level are information known to the user. For instance, when the user is young, for instance, in 20s, the CPU 21 estimates that so-called youth language is information known to the user. When the words and graphics thus estimated to be the information known to the user are excluded from the words and graphics recognized in step S106, the remaining words and graphics can be identified as the information unknown to the user, in other words, the desired information.

As the search processor 209, the CPU 21 performs search processing to search for relevant information in the database 40 using the words and graphics identified as the desired information as search information (step S109). The details of search processing will be described later.

The CPU 21 determines whether or not desired information associated with relevant information has been selected by the search processing (step S110). As described above, desired information is selected by clicking a word or a graphic identified as the desired information on the image 500 of the answer sheet 50 in the screen illustrated in FIG. 6. When desired information is not selected (NO in step S110), the CPU 21 causes the flow to proceed to the processing in step S113. When desired information is selected (YES in step S110), as the providing unit 210, the CPU 21 displays relevant information related to the desired information as the thumbnails 600 and the detail 601 on the screen illustrated in FIG. 6 (step S111).

As the feedback processor 211, the CPU 21 receives feedback from the user for the displayed relevant information (step S112). When the preference of the user is fed back, the CPU 21 stores the feedback result in the storage 24 as the search history storage 207.

The CPU 21 determines whether or not checking of the answer information is completed by the user (step S113). Whether or not checking of the answer information is completed can be determined, for instance, based on whether or not the screen illustrated in FIG. 6 is closed by the user. Specifically, keeping the screen open by the user indicates that checking of the answer information is on-going, and closing the screen by the user indicates that checking of the answer information is completed. When checking of the answer information is not completed (NO in step S113), the CPU 21 repeats the processing from step S110, and when another desired information is selected, relevant information related to the desired information is displayed. When checking of the answer information is completed (YES in step S113), the CPU 21 updates the user information based on the desired information not utilized, specifically, the desired information not selected in step S110 (step S114). Specifically, the desired information not selected is not the information desired by the user, thus is added to the search exclusion list 220 illustrated in FIG. 5.

Next, the search processing in step S109 will be described.

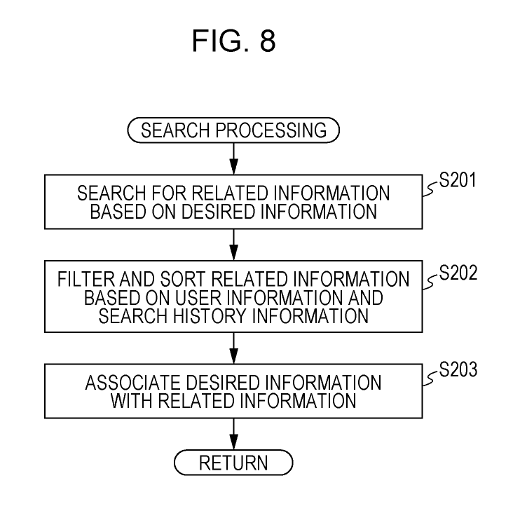

FIG. 8 is a flowchart illustrating the flow of the search processing.

The CPU 21 searches for relevant information in the database 40 based on the desired information identified in step S108 (step S201). The CPU 21 then performs filtering and sorting of multiple pieces of relevant information obtained from the database based on the user information (step S202).

Regarding the filtering and sorting, the CPU 21 refers to the user information for age for instance, and performs filtering and sorting of multiple pieces of relevant information according to the preferences of people in the same age group. The preferences of people in the same age group can be estimated from the preferences of other users stored in the search history storage 207. In addition, the CPU 21 refers to the user information for history as teacher, and performs filtering and sorting of multiple pieces of relevant information according to the preferences of other users having approximately the same history as teacher. When the feedback in step S112 indicates that one of the multiple pieces of relevant information displayed is a favorite site of the user, the preference of the user is stored in the search history storage 207. The CPU 21 sorts multiple pieces of relevant information obtained by searching based on the information on search history stored in the search history storage 207 so that the order of priority of the relevant information obtained from the favorite site of the user is increased. Conversely, when the feedback indicates that a piece of relevant information is not a favorite site of the user, the CPU 21 decreases the order of priority of the relevant information from the same site, or prevents the relevant information from the same from being displayed by filtering.

The CPU 21 associates the desired information with relevant information (step S203). Consequently, when desired information in the area 503 is clicked on the screen illustrated in FIG. 6, the thumbnails 600 and the detail 601 are displayed as the relevant information.

Various changes and improvements may be made to the information processing device 20 in the exemplary embodiment within the scope of the technical idea of the present disclosure.

In the exemplary embodiment, an example has been described in which answers to questions are acquired as the answer sheets 50. However, answers to questions may be acquired in various manners. For instance, answers to questions may be acquired by recitation. In this case, voice data obtained by recitation is converted into character data by the answer acquisition device 10. After the conversion into character data, similarly to the exemplary embodiment, natural language processing is performed on the character data, and desired information is identified. In this manner, the function of the information processing device 20 is applicable not only to the answers to tests, but also to answers obtained in a situation such as a workshop or group discussion.

In the exemplary embodiment, relevant information related to identified desired information may be utilized by a user. Meanwhile, a word which is not identified as the desired information may be actually desired by a user. In such a situation, for instance on the screen illustrated in FIG. 6, the information processing device 20 may allow a user to underline a desired word on the image 500 of the answer sheet 50, or surround the desired word with a rectangular area. The information processing device 20 newly identifies the word underlined by a user as the desired information, searches for relevant information related to the identified desired information in the database 40, and allows the user to utilize the relevant information.

Alternatively, a user may click (press down) a reload button 700 on the screen illustrated in FIG. 6 so that a new word may be identified newly as the desired information. In this case, for instance each time the reload button 700 is clicked by a user, the information processing device 20 identifies desired information by considering each of the words registered in the search exclusion list 220 of the user information as an unregistered word. The order of considering each of the words as an unregistered word is, for instance, the order of new registration of the words in the search exclusion list 220. Thus, the number of words, for which search is excluded by the search exclusion list 220, is decreased, and conversely, the number of words as a search target, in other words, the number of words identified as the desired information is increased. Each of the words considered to be unregistered in the search exclusion list 220 by a user's clicking of the reload button 700 is deleted from the search exclusion list 220 if desired information identified based on the word is utilized by the user.

In the exemplary embodiment, addition of a word to be registered in the search exclusion list 220 has been described. However, not only a word is simply added, but also words of a high-level concept may be extracted, for instance, by grouping multiple words, and may be added to the search exclusion list 220.

Also, in the exemplary embodiment, when filtering and sorting are performed on multiple pieces of relevant information obtained from the database based on the user information, the filtering and sorting are in accordance with the preferences of other users having similar user information. However, the filtering and sorting do not have to be performed in accordance with the preferences of other users. For instance, keywords corresponding to user information are preset, relevant information is searched for in the database 40 using desired information and the preset keywords as AND condition, and thus the relevant information may be filtered and sorted. For instance, when the age in the user information indicates 20s, a keyword, “is . . . ” is preset. Relevant information is searched for using desired information and “is . . . ” as AND condition, thus a site including the content such as “X (desired information) is . . . ” is among the top of search results. The above-mentioned preset keyword is merely an example. A preset keyword is determined as appropriate by investigating what type of secondary keywords are used by a user for searching according to age, sex, or history as teacher.

The above-described information processing can also be implemented by a dedicated hardware circuit. In this case, the information processing may be performed by a single piece of hardware or multiple pieces of hardware.

Also, a program, which causes the information processing device 20 to operate, may be provided by a computer-readable recording medium such as a Universal Serial Bus (USB) memory, a flexible disk, a compact disc read only memory (CD-ROM), or may be provided on-line via a network such as the Internet. In this case, the program recorded on a computer-readable recording medium is normally transferred to and stored in a memory or a storage. Also, the program may be provided as a single application software, or may also be incorporated in software as a function of the information processing device 20.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising
a providing unit that identifies information desired by a user from among answers to questions, and that, when relevant information related to the identified desired information is acquired, provides the relevant information to the user.

2. The information processing device according to claim 1,
wherein the answers include at least one of video data, voice data, image data, and character data.

3. The information processing device according to claim 1,
wherein the relevant information is acquired as a search result of searching in a database by a search processor using the desired information as search information.

4. The information processing device according to claim 2,
wherein the relevant information is acquired as a search result of searching in a database by a search processor using the desired information as search information.

5. The information processing device according to claim 3,
wherein the search processor identifies a character, a character string, or a graphic designated by a user from the answers as the desired information.

6. The information processing device according to claim 4,
wherein the search processor identifies a character, a character string, or a graphic designated by a user from the answers as the desired information.

7. The information processing device according to claim 3,
wherein from characters and character strings extracted from the answers by natural language processing, the search processor identifies at least one of characters and a character string desired by a user as the desired information based on user information on the user.

8. The information processing device according to claim 4,
wherein from characters and character strings extracted from the answers by natural language processing, the search processor identifies at least one of characters and a character string desired by a user as the desired information based on user information on the user.

9. The information processing device according to claim 7, further comprising
a feedback processor that feeds back a result of utilization of the relevant information by a user,
wherein the search processor excludes the relevant information which has not been utilized from a target of acquisition, based on feedback by the feedback processor.

10. The information processing device according to claim 8,
a feedback processor that feeds back a result of utilization of the relevant information by a user,
wherein the search processor excludes the relevant information which has not been utilized from a target of acquisition, based on feedback by the feedback processor.

11. The information processing device according to claim 7,
wherein when a plurality of pieces of relevant information, each of which is the relevant information, are obtained as the search result from the database,
the search processor arranges the plurality of pieces of relevant information in accordance with an order of priority determined based on the user information.

12. The information processing device according to claim 8,
wherein when a plurality of pieces of relevant information, each of which is the relevant information, are obtained as the search result from the database,
the search processor arranges the plurality of pieces of relevant information in accordance with an order of priority determined based on the user information.

13. The information processing device according to claim 9,
wherein when a plurality of pieces of relevant information, each of which is the relevant information, are obtained as the search result from the database,
the search processor arranges the plurality of pieces of relevant information in accordance with an order of priority determined based on the user information.

14. The information processing device according to claim 10,
wherein when a plurality of pieces of relevant information, each of which is the relevant information, are obtained as the search result from the database,
the search processor arranges the plurality of pieces of relevant information in accordance with an order of priority determined based on the user information.

15. The information processing device according to claim 11, further comprising
a feedback processor that receives evaluation of a user for the plurality of pieces of relevant information arranged in accordance with the order of priority,
wherein the search processor changes the order of priority according to the evaluation received by the feedback processor.

16. The information processing device according to claim 12, further comprising
a feedback processor that receives evaluation of a user for the plurality of pieces of relevant information arranged in accordance with the order of priority,
wherein the search processor changes the order of priority according to the evaluation received by the feedback processor.

17. The information processing device according to claim 13, further comprising
a feedback processor that receives evaluation of a user for the plurality of pieces of relevant information arranged in accordance with the order of priority,
wherein the search processor changes the order of priority according to the evaluation received by the feedback processor.

18. The information processing device according to claim 3, further comprising
a display that displays the desired information,
wherein in response to selection of the desired information displayed on the display by a user, the search result related to the desired information is displayed on the display.

19. An information processing method comprising:
identifying information desired by a user from among answers to questions; and
when relevant information related to the identified desired information is acquired, providing the relevant information to the user.

20. A non-transitory computer readable medium storing an information processing causing a computer to execute a process, the process comprising:
identifying information desired by a user from among answers to questions; and
when relevant information related to the identified desired information is acquired, providing the relevant information to the user.
